(19) United States
(12) Patent Application Publication
(10) Pub. No.: US 2006/0129311 A1
(43) Pub. Date: Jun. 15, 2006

(54) Remote navigation server interface

(76) Inventors: Jason Bauman, Huntington Woods, MI (US); Jody K. Harwood, Canton, MI (US); Ken Rudnick, Bloomfield Hills, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 11/008,387

(22) Filed: Dec. 9, 2004

(51) Int. Cl. G01C 21/26

(52) U.S. Cl. 701/201; 701/209; 340/995.23

(57) ABSTRACT

A method is provided for generating a destination address in response to a plurality of oral inputs by a user. The user is prompted to orally input a primary geographical descriptor of the destination address to the in-vehicle navigation module. Primary geographical utterance data is generated in response to an oral input by the user. The primary matching voice templates stored in the in-vehicle navigation module are compared with the primary geographical utterance data. The secondary voice templates associated with the secondary geographical descriptors within the primary geographical descriptors are retrieved from the remote navigation server. The secondary geographical utterance data is generated in response an oral input by the user. The stored secondary voice templates are compared with the secondary geographical utterance data. The destination address is generated in response to matching voice templates. The destination address is provided to a remote navigation server for calculating route guidance directions.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates in general to vehicle navigation systems, and more specifically, to interfacing with an remote navigation server for retrieving route guidance directions to a destination address.

2. Description of the Related Art

Traditional vehicle navigation systems utilize an on-board navigation device that contains in a database of the geographic map data within its on-board memory and a processor for determining route guidance directions. These systems utilize the map data stored on-board in its memory for generating the directions. Additional geographical areas or updated map data may be added to the on-board navigation memory via a CD or other transferable storage medium. However, this requires that the on-board navigation device have a large amount of memory to store the map data.

Other navigation systems utilize an off-board navigation server for supplying map data to the in-vehicle navigation device via a wireless connection. The map data is retrieved from the off-board navigation server and is provided to the in-vehicle navigation module. In systems that use speech recognition to communicate between the user and from the in-vehicle navigation device, vocabulary map data is stored in in-vehicle navigation device's memory. However, this requires that a very large amount of memory is required to store the vocabulary map data for all potential destination addresses for a plurality of geographical areas.

### SUMMARY OF THE INVENTION

The present invention has the advantage of decreasing the amount of memory required to store voice templates for a plurality of geographical locations on an in-vehicle navigation module by utilizing an off-board navigation server to store the voice templates where respective voice templates are retrieved from the off-board navigation server to an in-vehicle navigation module in response to geographical descriptors orally input to the in-vehicle navigation module by the user.

In one aspect of the present invention, a method is provided for generating a destination address in response to a plurality of oral inputs by a user. The user is prompted to orally input a primary geographical descriptor of the destination address to the in-vehicle navigation module. Primary geographical utterance data is generated in response to an oral input by the user. The primary matching voice templates stored in the in-vehicle navigation module are compared with the primary geographical utterance data. The secondary voice templates associated with the secondary geographical descriptors within the primary geographical descriptors are retrieved from the remote navigation server. The secondary geographical utterance data is generated in response an oral input by the user. The stored secondary voice templates are compared with the secondary geographical utterance data. The destination address is generated in response to matching voice templates. The destination address is provided to a remote navigation server for calculating route guidance directions.

### BRIEF DESCRIPTION OF THE DRAWINGS

FIG. 1 is a block diagram of an off-board navigation system according to a preferred embodiment of the present invention.

FIG. 2 is a method for interfacing with an off-board navigation server according to a preferred embodiment of the present invention.

### DETAILED DESCRIPTION OF PREFERRED EMBODIMENTS

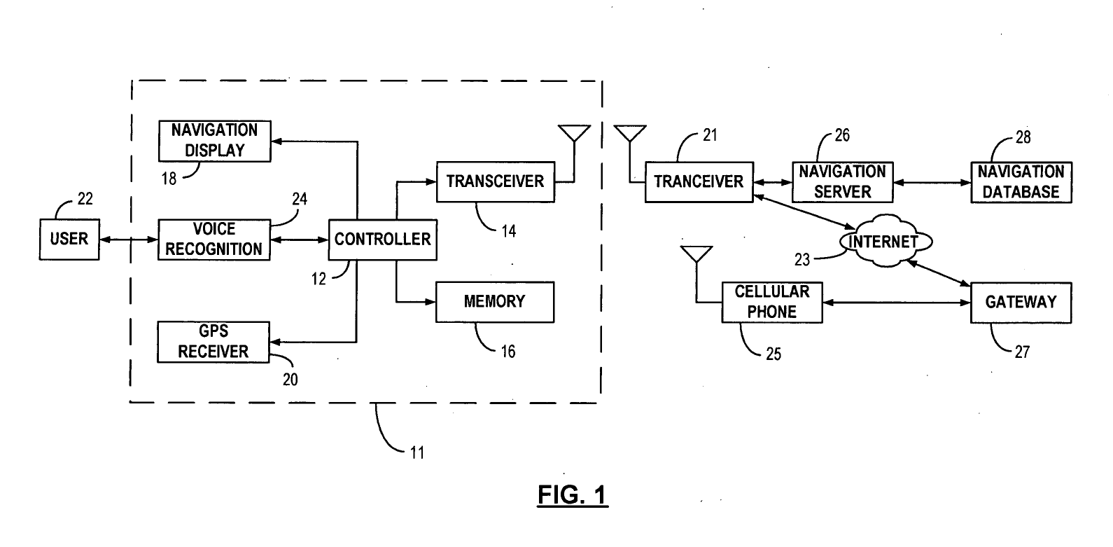

FIG. 1 illustrates an off-board vehicle navigation system for providing route guidance directions to an in-vehicle navigation module. An in-vehicle navigation module 11 is disposed within the interior compartment of a vehicle. Alternatively, the in-vehicle navigation module 11 may be a portable device that may be used remotely from the vehicle. The in-vehicle navigation module 11 is an interface device which prompts a user 22 to iteratively input portions (e.g., descriptors) of a destination address. The in-vehicle navigation module communicates with a remote navigation server 26 to retrieve map data in the form of voice templates related to the geographical location of the destination address for which the user 22 may iteratively make selections from. When each of the descriptors of the destination address is fully entered, the destination address is transmitted to the remote navigation server 26 for calculating route guidance directions. After the route guidance directions have been calculated, the remote navigation server 26 provides the route guidance directions to the in-vehicle navigation module 11 which is output to the user. Additionally, descriptors of an origin address may be iteratively input to the in-vehicle navigation module 11 for establishing a current location and for calculating route guidance directions to the destination address.

The in-vehicle navigation module 11 includes a controller 12 for controlling the communication of data between a user 22 and the remote navigation server 26. The in-vehicle navigation module 11 further includes a transceiver 14 for broadcasting the destination address orally entered by the user to the remote navigation server 26. The transceiver 14 also receives map data in the form of voice templates from the remote navigation server 26 relating to each of the destination address descriptors entered. The in-vehicle navigation module 11 also includes a memory storage device 16 for storing voice templates. In the preferred embodiment, the memory storage device 16 is a secondary storage database having limited storage capacity while the navigation database 28 of the remote navigation server 26 is a primary storage database which includes a plurality of the voice templates for a plurality of geographical locations. The remote navigational database 28 may be integral to the navigation server 26 or may be a remote storage database.

The memory storage device 16 is of sufficient capacity to permanently store voice templates of primary geographical descriptors. In the preferred embodiment, the primary geographical descriptors include state names and city names. Voice templates of secondary geographical descriptors such as street names and street address numbers are stored in the remote navigational database 28, although the city names may be stored in the voice templates of secondary geographical descriptors within the remote navigation database 28. Furthermore, the memory storage device 16 may be of a sufficient capacity to store voice templates of both primary and secondary geographical descriptors of the most frequently visited locations. This alleviates the need for the in-vehicle navigation module 11 to repetitiously retrieve voice templates for those places that are often frequented. The controller 12 may maintain an on-going and up-to-date list of a predetermined number of destination addresses most frequently traveled to. The controller 12 may also allow the user 22 to enter a set number of destination addresses that the user may desire to maintain in the memory storage device 16.

The in-vehicle navigation module 11 includes a voice recognition software system 24 such as IBM's ViaVoice™. Alternatively, other voice recognition software may be used. The voice recognition software allows voice-input commands to be input by the user 22. Selections are input in the form of utterances to the in-vehicle navigation module 11 and a voice recognition software routine is applied to the utterance for comparing the utterance to the voice templates for determining the selection as spoken by the user 22. The voice recognition software also generates verbal output commands in the form of prompts for requesting the user to input a descriptor of the destination address.

Choices for selection of the descriptor of the destination address may be displayed to the user 22 via a navigation display screen 18. The navigation display screen 18 includes a display screen such as a LCD screen for visually displaying the potential choices or the route guidance directions to the user 22. Alternatively, the navigation display screen 18 may include a plurality of contact switches or a touch screen for making selections in a menu-style system.

In the preferred embodiment, a wireless communication device such as a cellular phone 25 establishes a gateway 27 to the internet 23 for providing a connection between the transceiver 14 of the in-vehicle navigation module 11 and the a transceiver 21 of a remote navigation server 26. A wireless communication protocol such as Bluetooth™ may further be used to establish a communication link between the mobile phone and the transceiver 14 of the in-vehicle navigation module 11. Alternatively, the transceiver 14 of the in-vehicle navigation module 11 may establish a direct wireless connection to the transceiver 21 of the remote navigation server 26.

The remote navigation server 26 includes a microcontroller such as a microprocessor for calculating route navigation directions based on the in-vehicle navigation module's current location. Detailed map data is stored in the memory of the remote navigation server and the desired destination. The microcontroller retrieves the map data based on the descriptors of the destination address entered by the user 22 and calculates route guidance directions in response the in-vehicle navigation module's location and the entered destination address. By utilizing the memory of the remote navigation device for storing voice templates in cooperation with a high speed processor of the controller 12 for remotely calculating route guidance directions, lower costs can obtained by not having to integrate high capacity storage devices and high speed processors within the in-vehicle navigation module 11. Furthermore, to minimize the downloading time of the voice templates transmitted between the off-vehicle navigation device 11 and the remote navigation server 26, phonetic representations are utilized. Phonetic representations include symbols each representing one or more words. For example, a street named “Diamond St” may be represented by a diamond symbol as opposed to downloading each letter of the word “Diamond”. Downloading the phonetic representation of voice templates not only minimizes the amount of data to be downloaded, but the processing and downloading time is expedited as well.

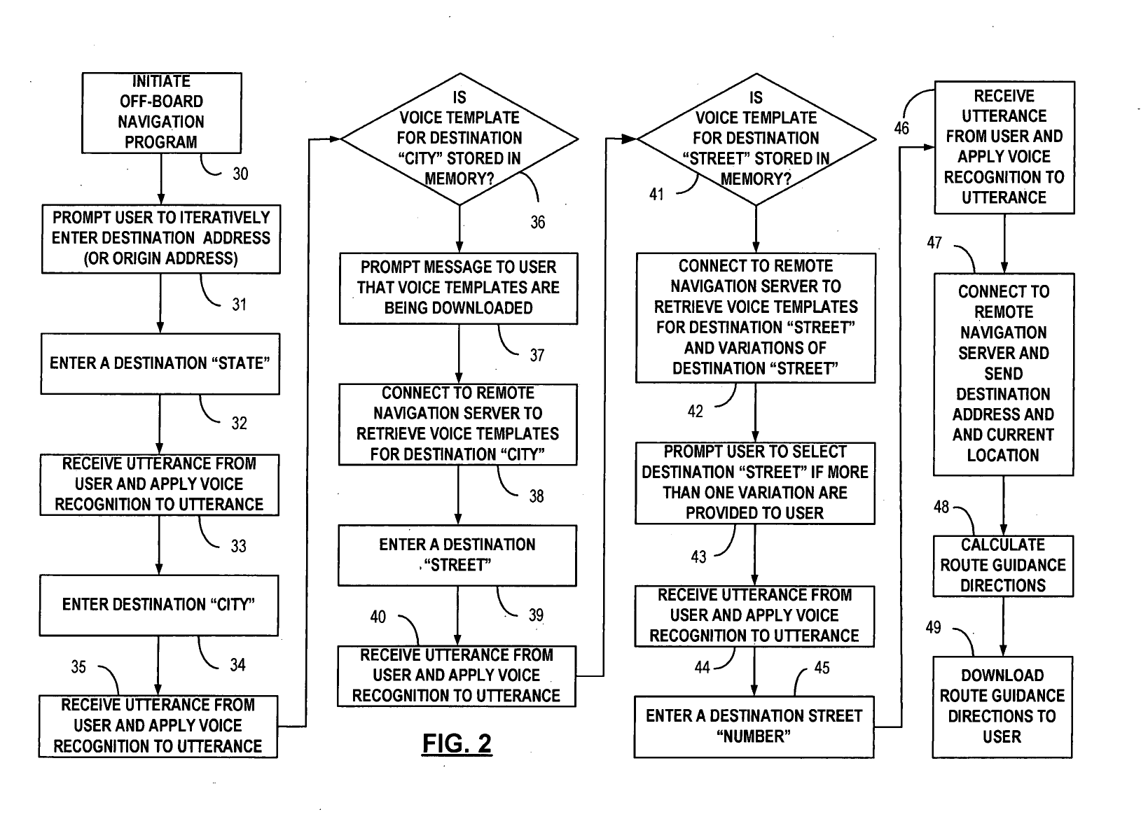

FIG. 2 illustrates a method of interfacing navigational map data between a user and a remote navigation server. In step 30, an off-board navigation program is initiated. In step 31, an in-vehicle navigation module prompts the user to iteratively enter descriptors of a destination address. Information transferred between the user and the in-vehicle navigation module is accomplished through the speech recognition system by prompting the user with verbal output commands and receiving utterances (i.e., spoken words) as input commands by the user. The output commands prompted to the user may also be displayed to the user via the visual display screen such as the LCD screen. In step 32, the in-vehicle navigation module prompts the user to enter a destination “state”. In step 33, the in-vehicle navigation module receives an utterance (i.e., state name) identifying a respective destination “state” and applies a voice recognition routine in response to the utterance. A comparison is made between the utterance and the voice templates stored in the memory of the in-vehicle navigation module. In step 34, the in-vehicle navigation module prompts the user to enter a destination “city”. In step 35, the in-vehicle navigation module receives an utterance (city name) by the user identifying a respective destination “city” and applies a voice recognition routine in response to the utterance. A comparison is made between the utterance and the voice templates stored in the memory of the in-vehicle navigation module.

In step 36, a determination is made whether voice templates containing street names for the destination “city” are locally stored in the memory of the in-vehicle navigation module. The street names voice templates for a respective destination “city” includes voice templates for all known streets within the destination “city” as already identified. If the street names voice templates are already stored locally in the memory of the in-vehicle navigation module, then the user is prompted by the in-vehicle navigation module to enter a destination “street” in step 39. If the street names voice templates are not locally stored in the memory of the in-vehicle navigation module, then a message is output to the user to wait while the street names voice templates are retrieved from the remote navigation server in step 37. In step 38, a connection is made from the in-vehicle navigation module to the remote navigation server via the mobile phone for retrieving the street names voice templates associated with the destination “city”. The street names voice templates for the destination “city” are retrieved from the memory of the off-board navigation device and are downloaded to the in-vehicle navigation module via the mobile phone connection. The user is then prompted to enter the destination “street” in step 39. In step 40, the in-vehicle navigation module receives an utterance identifying a destination “street” orally input by the user and applies a voice recognition routine for the utterance. A comparison is made between the utterance and the street names voice templates. In step 41, a determination is made whether voice templates containing street variations and associated street address numbers for the destination “street” is locally stored in the memory of the in-vehicle navigation module. If the street address numbers voice templates for all destination street variations are stored locally, then all possible streets having a same street base-name as the destination “street” is made available to the user to select from in step 43. For example, the speech recognition device may identify a plurality of streets within a city having a same basename. Each street is then verbally communicated to the user with a respective selection number from which to choose from.

If the street address numbers for each destination street variation is not stored locally, then the user is prompted to wait while a connection is made to the off-board navigation device. Voice templates associated with the destination street address numbers for all destination street variations are retrieved and downloaded to the in-vehicle navigation module in step 42. In step 43, one or more variations of the destination “street” are provided to the user and the user is prompted to select from the list. In step 44, the in-vehicle navigation module receives an utterance input by the user identifying the selected destination “street” and a voice recognition routine is applied to the utterance. In step 45, the in-vehicle navigation module prompts the user to enter the destination street address “number” for the selected destination “street”. In step 46, the in-vehicle navigation module receives the utterance identifying the destination street address “number” and a voice recognition routine is applied to the utterance. A comparison is made between the utterance and the street address number voice templates. In step 47, the connection is made to the remote navigation server and the destination address (i.e., state, city, street, and street address) is provided to the off-board navigation device along with the current location. The current location may be retrieved by any known positioning method such as satellite positioning, a gyroscope, or dead reckoning system. In step 48, the remote navigation server calculates the route guidance directions based on the current in-vehicle navigation module's location and the destination address. In step 49, the route guidance directions are downloaded to the in-vehicle navigation module and output to the user.

Alternatively, an origin address may be specified in a same manner as is shown for determining the destination address. The origin address may be the current location or any other desired location.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method for generating a destination address in response to a plurality of oral inputs by a user, said destination address provided to a remote navigation server for calculating route guidance directions, said method comprising the steps of:
prompting said user to orally input a primary geographical descriptor of said destination address to said in-vehicle navigation module;
generating primary geographical utterance data in response to an oral input by said user;
comparing primary matching voice templates stored in said in-vehicle navigation module with said primary geographical utterance data;
retrieving secondary voice templates associated with secondary geographical descriptors within said primary geographical descriptors from said remote navigation server;
generating secondary geographical utterance data in response an oral input by said user;
comparing said secondary voice templates stored with said secondary geographical utterance data; and
generating said destination address in response to matching voice templates.

2. The method of claim 1 wherein said primary geographical descriptors are stored permanently in said in-vehicle navigation module.

3. The method of claim 2 wherein said step of retrieving voice templates associated with said primary geographical descriptors from said remote navigation server is performed only if a determination is made that said voice templates associated with said primary geographical descriptors is not stored in said in-vehicle navigation module.

4. The method of claim 1 wherein portions of said secondary geographical descriptors are stored permanently in said in-vehicle navigation module.

5. The method of claim 4 wherein said step of retrieving secondary voice templates associated with said secondary geographical descriptors from said remote navigation server is conditional only if a determination is made that said voice templates associated with said secondary geographical descriptors is not stored in said in-vehicle navigation module.

6. The method of claim 1 further comprising the steps of determining a origin address, said origin address and said destination address are transmitted to said remote navigation server for determining route guidance directions.

7. The method of claim 6 wherein step of determining said origin address comprises:
prompting said user to orally input a primary geographical descriptor of said origin address to said in-vehicle navigation module;
generating primary geographical utterance data in response to an oral input by said user;
comparing primary matching voice templates stored in said in-vehicle navigation module with said primary geographical utterance data;
retrieving secondary voice templates associated with secondary geographical descriptors within said primary geographical descriptors from said remote navigation server;
generating secondary geographical utterance data in response to an oral input by said user;
comparing said secondary voice templates stored with said secondary geographical utterance data ; and
generating said origin address in response to matching voice templates.

8. The method of claim 4 wherein said origin address is determined by a global positioning system.

9. The method of claim 1 wherein said step of entering said primary geographical descriptor of said destination address includes orally entering a name of a state.

10. The method of claim 9 wherein said step of entering said primary geographical descriptor of said destination address includes orally entering a name of a city.

11. The method of claim 1 wherein said step of entering said secondary geographical descriptor of said destination address includes entering a street name.

12. The method of claim 1 wherein said step of entering said secondary geographical descriptor of said destination address includes entering a street address number.

13. The method of claim 1 wherein said in-vehicle navigation module is wirelessly connected to said remote navigation server via a cellular telephone.

14. The method of claim 1 wherein said steps of prompting said user to input portions of said destination address are displayed to said user via a display screen.

15. A method for generating a destination address in response to a plurality of oral inputs by a user, said destination address provided to a remote navigation server for calculating route guidance directions, said method comprising the steps of:
prompting said user to orally input a state name of said destination address to said in-vehicle navigation module;
generating state name utterance data in response to an oral input by said user;
comparing state name voice templates stored in said in-vehicle navigation module with said state name utterance data;
prompting said user to orally input a city name of said destination address to said in-vehicle navigation module;
generating city name utterance data in response to an oral input by said user;
comparing city name voice templates stored in said in-vehicle navigation module with said city name utterance data;
retrieving street names voice templates associated with said city name from said remote navigation server if said street name voice templates for said city name are not stored in said in-vehicle navigation module;
prompting said user to orally input a street name of said destination address to said in-vehicle navigation module;
generating street name utterance data in response to an oral input by said user;
comparing street name voice templates stored in said in-vehicle navigation module with said street name utterance data;
retrieving street address number voice templates associated with said street name from said remote navigation server if said street address number voice templates are not stored in said in-vehicle navigation module; and
prompting said user to orally input a street address number of said destination address to said in-vehicle navigation module;
generating street address number utterance data in response to an oral input by said user;
comparing street address number voice templates stored in said in-vehicle navigation module with said street address number utterance data;
generating said destination address in response to said matched voice templates.

16. The method of claim 15 wherein said step of retrieving said street name voice templates from said remote navigation server further comprises the steps of:
retrieving a plurality of street names having a variations of said street name orally input by said user;
prompting said user to select a respective street name if more than one variation of said street name is present;
prompting said user to enter secondary descriptive street name information; and
retrieving secondary descriptive voice templates from said remote navigation server.

17. A route guidance navigation system comprising:
an in-vehicle navigation module for interfacing with a user and for displaying route guidance directions to a user;
a remote navigation server for determining said route guidance directions, said remote navigation server including a database for storing a plurality of voice templates associated with geographical descriptors;
a wireless communication device for transferring said voice templates between said remote navigation server and said in-vehicle navigation module; and
a speech recognition system for recognizing said user oral inputs, generating utterance data, and comparing said user utterance data to said voice templates;
wherein said in-vehicle navigation module prompts said user to input portions of a destination address, wherein said remote navigation server provides to said in-vehicle navigation module respective voice templates in response to said user utterance data, and wherein said in-vehicle navigation module provides said destination address to said remote navigation server for determining said route guidance directions.

18. The system of claim 14 wherein said wireless communication device includes a cellular telephone.

19. The system of claim 14 wherein said in-vehicle navigation module prompts said user to input portions of a origin address, wherein said remote navigation server provides to said in-vehicle navigation module respective voice templates in response to said user utterance data, and wherein said in-vehicle navigation module provides said origin address to said remote navigation server for determining said route guidance directions.
